(19) United States
(12) Patent Application Publication
(10) Pub. No.: US 2008/0062510 A1
(43) Pub. Date: Mar. 13, 2008

(54) Method for Selecting a Wavelength, and a Microscope

(75) Inventors: Burkhard Spill, Ebsdorfergrund (DE); Wolfgang Vollrath, Burbach (DE); Maximilian Dobler, Dutenhofen (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GmbH, Weilburg (DE)

(21) Appl. No.: 11/759,188

(22) Filed: Jun. 6, 2007

Related U.S. Application Data
(63) Continuation of application No. PCT/EP05/56448, filed on Dec. 2, 2005.

(30) Foreign Application Priority Data
Dec. 6, 2004 (DE) DE102004058728

(51) Int. Cl. G02B 21/00; G01J 3/28

(52) U.S. Cl. 359/368; 356/326

(57) ABSTRACT

A method is disclosed for selecting a minimum of one wavelength 320 or a minimum of one wavelength range 206 of electromagnetic radiation to be used for object testing, whereby a first spectrum is captured or calculated on a first point of a first object 509, a second spectrum is captured or calculated on a second point of the first 509 or a second object, a difference spectrum is formed from the first and the second spectrum, and the minimum of one wavelength 320 or minimum of one wavelength range 26 is selected in the difference spectrum according to predetermined criteria; as well as a microscope 500 with means of the illumination 502, capture 503, and analysis 504, whereby the illumination means illuminate an object 509, and the capture means capture a first spectrum on a first point on a first object, the capture means capture a second spectrum on a second point of the first or on a second object, and the analysis means form a difference spectrum as a difference between the first and the second spectrum. The disclosed invention enables selection of an optimally suited wavelength for object testing.

The invention relates to a method for selecting a minimum of one wavelength or a minimum of one wavelength range of electromagnetic radiation to be used for testing an object, whereby a first spectrum is captured on a first point on an object. The invention further relates to a microscope with means of illumination, capture, and analysis, whereby the illumination means illuminate an object, and the capture means capture a first spectrum on a first point on the object. Finally, the invention relates to a computer program and a computer program product for implementing the selection process.

Object testing, for example using a microscope, is conventionally conducted with light or general electromagnetic radiation with discrete wavelengths, continuous narrow- or broadband radiation spectrum. It is understood that the various wavelengths, geometric relationships, and other optical effects such as polarization and phase contrast in a continuous spectrum have various effects on the imaging characteristics. Application-specific optimization of the imaging settings of a microscope are currently implemented intuitively and individually, i.e., dependent on the user. As a result, the achieved results vary according to the training and experience of the user.

In addition to the known mechanical possibilities such as aperture, brightness, and focus settings, the selection of the optimal illumination wavelength provides a further possibility for optimizing contrast, for example, the illumination light wave in particular can be changed over broad ranges such that the optimal selection and setting is not a trivial matter for the user to accomplish.

For example, the illumination can be implemented with a defined wavelength, with a variable wavelength range around a defined wavelength, or with a continuous spectrum, in which a defined wavelength or wavelength range is blocked out.

In conventional use, the user attempts to find the optimal illumination range for particular requirement. The success of this procedure, in turn, is dependent largely on the experience and training of the user. US 2003/0206650 describes a first step for automating such a procedure. A method for operating an optical system is presented in which an illumination wavelength control parameter is determined in that the range of interest is radiated with a continuously changeable light, and the wavelength of the radiation is changed for as long as it takes for the image of the range of interest to exhibit adequate image characteristics. An iterative method is disclosed that is therefore relatively time-consuming. The decision as to when the image characteristics are adequate is left to the user.

The object of the present invention is therefore to provide a method by means of which the selection of a wavelength or of a wavelength range can be carried out quickly and largely automatically.

This object is solved according to the invention by a method for selecting a minimum of one wavelength or a minimum of one wavelength range of an electromagnetic radiation used for object testing, whereby one first spectrum, that is, the dependence of the reflected, transmitted, or mediated intensity on the wavelength of the electromagnetic radiation, is captured or calculated on a first point on a first object, a second spectrum on a second point on the first or on a second object is captured or calculated, a difference spectrum is formed from the first and the second spectrum, and a minimum of one wavelength or a minimum of one wavelength range is selected in the difference spectrum from predetermined criteria.

A plurality of known state-of-the-art methods exist for capturing a spectrum by experimental methods, which will not be further elucidated. In particular, given the current advancing capabilities of computer systems, it is, however, not necessary to use experimental methods to determine the spectrum. For example, the use of theoretical simulation calculations enables one to obtain spectrums that can be used by analogy with the present invention.

It is understood that a difference spectrum that is explicitly formed by carrying out a subtraction does not have to be used for the selection of the wavelength. For example, the wavelength can also be selected by displaying the spectrums in an image and analyzing the differences in intensity that occur, or by other means involving the comparison of two spectrums, without abandoning the scope of the present invention. The following description will largely refer to one selected wavelength or wavelength range, without implying a limitation in the number.

Selection according to predetermined criteria enables advantageous results that are independent of the training or experience of the user, and are in particular reproducible and comparable.

Preferably, the selection criteria of the method according to the invention comprises a maximal value in the difference spectrum. This is particularly advantageous if maximal contrast between the first and the second point is to be achieved. For this purpose, the wavelength or a wavelength range with a maximal value should be selected in the difference spectrum.

The selection criteria are always dependent on the case in use or application. For example, it can be equally advantageous to select a range with a minimal intensity value in the difference spectrum if a minimal contrast between the first point and the second point is desired, for example to suppress points that interfere with the observation. It is understood that one can also select a wavelength range, for example around a maximal or minimal value. It can also be advantageous to select a wavelength or a wavelength range with a predetermined difference from a wavelength with a maximal or minimal value in the difference spectrum. The optimal wavelength may also be preferably selected from a predetermined group, such as if a predetermined number of radiation means with defined wavelengths or wavelength ranges is available and the optimal radiation means is to be selected.

Depending on the case in use, it is preferable to select the first and the second point as well as the first and the second object or the first and the second sample. If, for example, a sample is to be tested that comprises various materials, it is sensible to capture the first spectrum at a first point with a first material and a second spectrum and a second point with the second material. If a sample is to be tested for defects, it is understood that the first spectrum should be captured on a first point with a defect and the second spectrum on a point without a defect. If a characteristic is of interest that is formed differently on different objects, the first and the second spectrums should be captured on different objects.

It is understood that any user-defined surface and/or object characteristic can be tested. Furthermore, let it again be expressly stated here that a spectrum can also be obtained in an identical manner by calculation, even in the examples in the above paragraphs.

Preferably, the object to be tested is illuminated with the selected wavelength or wavelength range. This can, for example, be implemented simply if a broadband, in particular a white light source, is applied with various color filters. In addition, radiation sources with a discrete suitable radiation spectrum can be used with equal simplicity, particularly laser or gas discharge lamps.

It is equally preferable if the selected wavelength or wavelength range for testing the object is detected in the electromagnetic radiation issuing from the object. This lends itself well when there is no possibility of varying the electromagnetic radiation used for illumination, for example by color filters, but rather the object is radiated, for example, with broadband, particularly white, radiation. In this case, for example, a camera with an adjustable color range can be used; a suitable color filter can just as easily be introduced into the radiation path of the radiation issuing from the object.

If the object to be tested comprises ranges from which issues significant interference during observation, the method according to the invention lends itself to selecting out the wavelength of interference. It is preferable to illuminate or to radiate the object being his wavelength is being tested with a wavelength or wavelength range different from the one selected out, or one that is different from this one. This embodiment of the invention enables one in a simple manner to decrease interference factors during observation or testing.

It is equally preferable to filter out the selected wavelength or selected wavelength range for testing the object in the electromagnetic radiation issuing from the object before detection, that is, to ignore it during observation.

The embodiments of the method according to the invention conform to the possibilities of the available testing system. In principle it is always possible to illuminate the object to be tested with the selected wavelength, or intentionally not to illuminate it, or to detect the selected wavelength only after illumination in the electromagnetic radiation issuing from the object, or not to detect it, that is, to ignore it.

A use of the method according to the invention for object testing in a microscope is preferred. The microscope is a standard device for object testing in which the method according to the invention can advantageously be used in a simple manner.

According to the invention, a microscope with means of illumination, capture, and analysis is disclosed, whereby the illumination means illuminates an object, and the capture means capture the first spectrum at a first point on a first object, the capture means capture a second spectrum on a second point on the first or a second object, and the analysis means forms a difference spectrum as a difference between the first and the second spectrum.

In a particularly preferred embodiment of the invention, the microscope has selection means that select a wavelength or a wavelength range in the difference spectrum according to predetermined criteria. In particular, the criteria comprise all criteria that have been described or will be described in connection with the method according to the invention and the embodiments thereof.

Advantageously, the selection means of the microscope according to the invention comprise a spectral camera. This enables sample illumination of the object with a conventional light source such as a halogen lamp because the spectral camera is able to determine a spectrum from the electromagnetic radiation issuing from the object. In the advantageous use of a spectral camera, a spectrum can be determined by a so-called “single shot,” in other words very quickly by means of a single capture.

It is equally advantageous if the analysis means and/or selection means of the microscope according to the invention comprise a computer unit. By using a computer unit, analysis of the spectrums or of the difference spectrums and/or the selection of the wavelength or of the wavelength range can be accelerated, and in particular completely automated.

A computer program according to the invention comprises a program coding means to implement the method according to the invention if the computer program is installed in a computer or a corresponding computer unit, in particular the analysis means and/or selection means in a microscope according to the invention.

A computer program product according to the invention comprises a program coding means that is stored on a readable data carrier to implement a method according to the invention if the computer program product is installed in a computer or in a corresponding computer unit, in particular the analysis means and/or selection means in a microscope according to the invention. Suitable data carriers include in particular diskettes, hard disks, flash memory, EEPROMs, CD-ROMs, among others. Downloading a program from a computer network (Internet, intranet, etc.) is also possible.

Further advantages and developments of the invention result from the description and the appended diagrams.

It is understood that the characteristics presently named and those to the explicated below are usable not only in the combination presented in each case, but rather in other combinations or as standalones as well, without abandoning the scope of the present invention.

### DESCRIPTION OF THE FIGURES

The invention will be explicated in greater detail based on the embodiment of the invention presented in the figures.

They show

FIG. 1 a flow diagram of an embodiment of the method according to the invention;

FIG. 2a a diagram with three spectrums that were calculated by simulation of a silicon surface of varying roughness;

FIG. 2b two diagrams, each with one spectrum, that were captured on silicone surfaces of varying roughness;

FIG. 2c three microscope images of a silicone surface, each of which was illuminated with different wavelengths; and

FIG. 3 a lateral view of an embodiment of a microscope according to the invention.

### DETAILED DESCRIPTION OF THE FIGURES

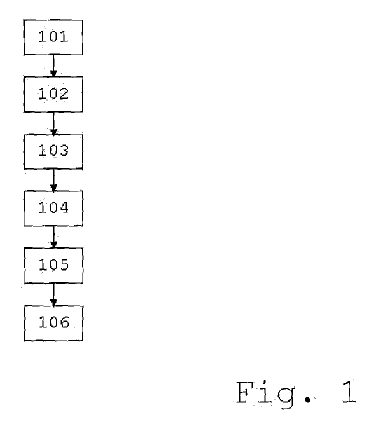

FIG. 1 shows a preferred embodiment of the method according to the invention. Reference is made to the particular case in use described below, without the method being limited to this case.

In the exemplary use, a wafer, in particular a silicone wafer, is to be tested for defects. Because of this, it is advantageous to achieve maximal contrast between defective and defect-free points.

The criteria for selecting the wavelength are predetermined in step 101. For object testing under maximal contrast it is predetermined that the wavelength be selected with the greatest intensity value in the difference spectrum.

In step 102, a spectrum is captured on a first point on the wafer, for example on a defect-free point.

In step 103, a spectrum is captured on a second point on the wafer. If the first spectrum was captured on a defect-free point, the second spectrum is captured on a defective point, and vice versa.

In step 104, the difference spectrum between the first and the second spectrum is then determined.

In step 105, the wavelength with the maximal value is selected in the difference spectrum according to the predetermined criteria.

Finally, in step 106, the wafer to be tested with the wavelength selected in step 105 is radiated.

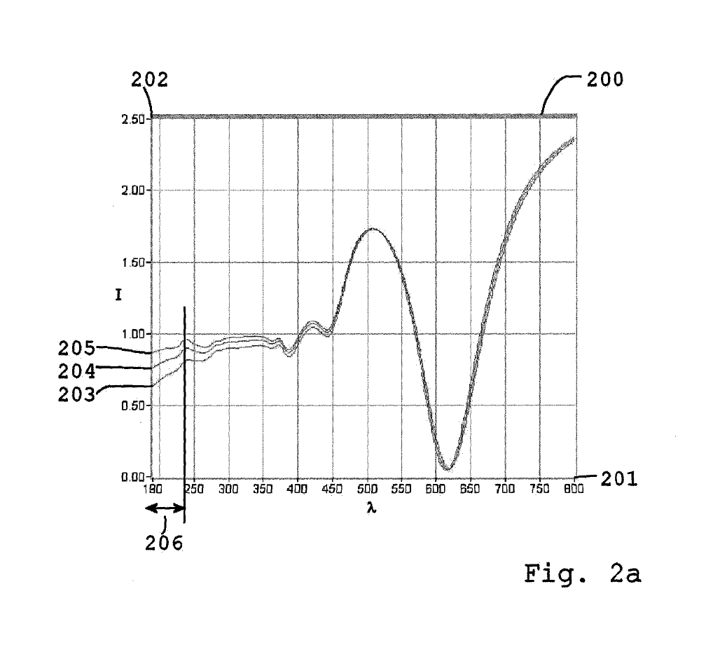

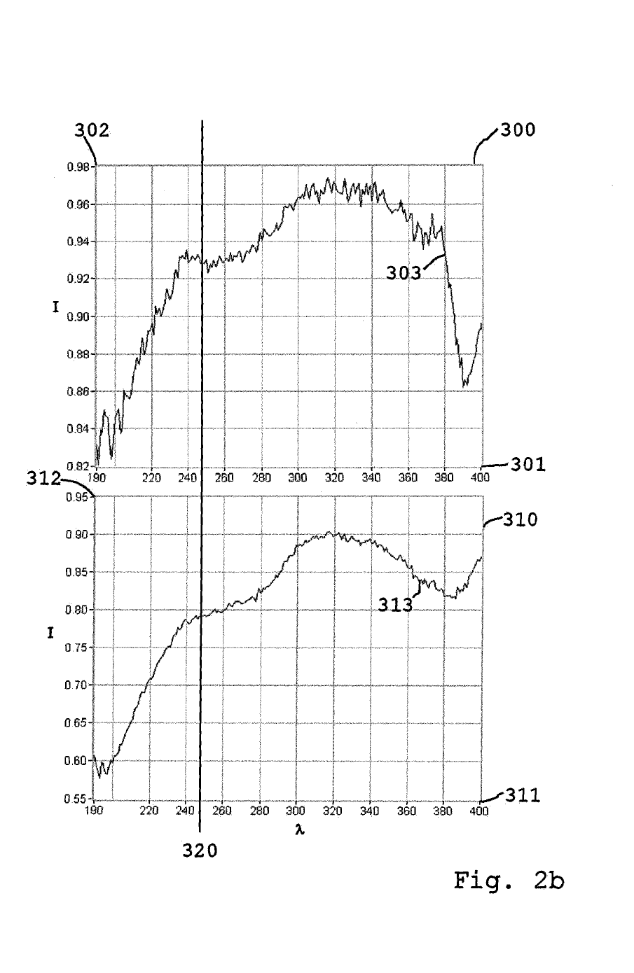

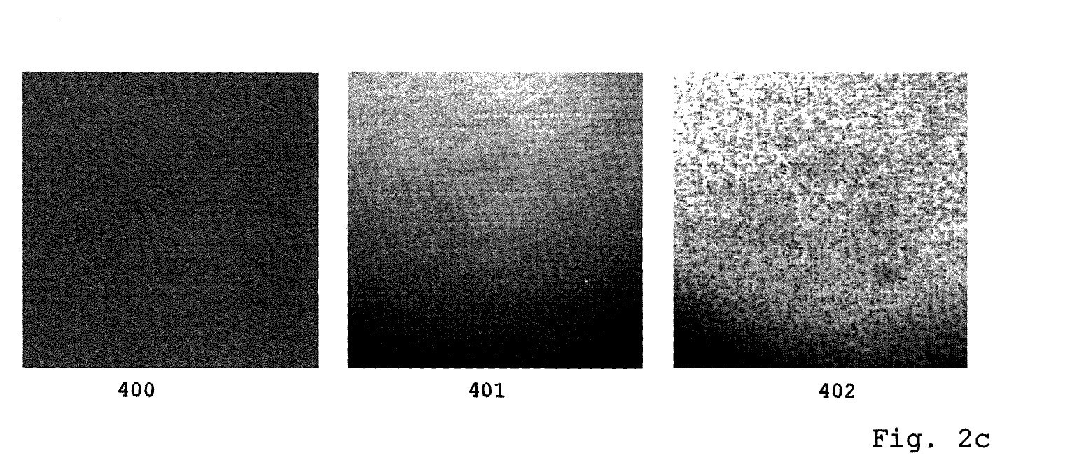

FIG. 2a shows three spectrums 203, 204, 205 in a diagram 200, which were obtained by theoretical simulation calculations. They each show a spectrum, in this case the dependence of the reflected intensity on wavelength. A silicon wafer, the surface of which can have various roughnesses, is observed. The roughness of the surface correlates directly with the displacement density.

The x-axis is designated as 201 and corresponds to wavelength λ. The selected unit is nm. The y-axis is designated as 202 and corresponds to the captured intensity I of the reflected radiation. The unit is arbitrarily selected.

Diagram 200 comprises a first spectrum 203, a second spectrum 204, and a third spectrum 205, which corresponds to the result of the simulation for three different preset displacement densities.

The greatest intensity difference between the spectrums is in the wavelength range of approximately 180 nm to 240 nm, which is designated as 206. The wavelength range 206 is in the DUV (deep ultraviolet) spectral range. This DUV spectral range will yield maximal contrast in a microscope during testing when illumination or detection is selected accordingly.

FIG. 2b shows two diagrams 300 and 310. The x-axes are designated as 301 and 311 and each corresponds to wavelength λ, whereby the nm unit is used. The y-axes are designated as 302 and 312, and correspond to the captured intensity I of the reflected radiation in arbitrary units.

Diagrams 300 shows a spectrum 303 that was captured on a silicon wafer at a first point with a relatively low displacement density. A spectral photometer, also designated as a reflectometer, was used.

Diagram 301 shows a spectrum 313 that was captured in the identical manner on a silicon wafer on a second point with increased displacement density.

Preferably, a wavelength is selected that yields high contrast during observation. Because of this, a wavelength should be selected in which both spectrums 303 and 313 have a high difference, if possible.

For example, a wavelength 320 is selected. The wavelength 320 has a value of 248 nm. At this selected wavelength, there occurs a difference in the reflected light intensity of approximately 14%, which results in high contrast during testing.

FIG. 2c shows three images 400, 401, and 402 of a silicon surface corresponding to FIGS. 2a and 2b. The images are captured in a microscope and show the surface of the silicon wafer, which is variably illuminated in each case.

In image 400, a white light with a broadband radiation spectrum is used for illumination. The contrast is poor, and the surface roughnesses are barely discernible.

In image 401, a UV light with a wavelength of 365 nm is used for illumination. Such a wavelength would, for example, be used by an experienced user who has determined this wavelength by intuitive experimentation. The contrast is better than in image 400; the surface roughnesses are somewhat discernible.

In image 402, a DUV light with a wavelength of 248 nm, selected according to the method according to the invention, is used (cf. FIGS. 2a and 2b). The contrast is high, and the surface roughnesses are easily discernible.

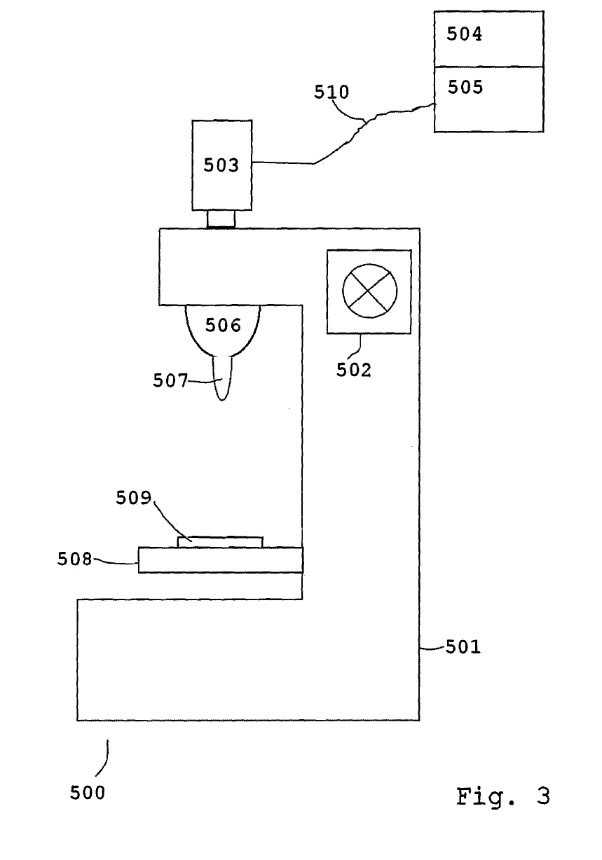

FIG. 3 shows a schematic lateral view of an embodiment of a microscope according to the invention. The complete microscope is designated as 500. It has a framework 501, illumination means 502 implemented as a lamp, a capture means 503 implemented as a spectral camera, and an analysis means 504 and selection means 505 implemented as a computer unit.

Further optical means such as lenses, apertures, mirrors, etc., which are designated as 506, are attached to the framework. An objective 507 is attached thereto.

An object to be tested 509 is placed on a specimen slide 508, which is attached to the framework 501. The light beam issues from the lamp 502, passes through the framework 501, within the optical means 506, and finally exits the objective 507. It is reflected by the object 509, again passes through the objective and the optical means, and reaches the spectral camera 503.

The spectral camera captures a spectrum, which is transmitted via a conventional data or video connection 510 to the computer unit 504, 505. In the analysis means of the computer unit 504, a difference spectrum is formed from two spectrums captured at various points on the object 509. In the analysis means of the computer unit 505, a wavelength or a wavelength range—as elucidated above—is selected in the difference spectrum according to predetermined criteria.

This selected wavelength or selected wavelength range can then be used for object testing, which can be conducted in the same or in any other microscope.

1. Method for selecting a minimum of one wavelength (320) or a minimum of one wavelength range (206) of electromagnetic radiation to be used for object testing, whereby a first spectrum (203, 204, 205; 303, 313) on a first point of a first object (509) is captured or calculated,
wherein
a second spectrum (203, 204, 205; 303, 313) is captured or calculated on a second point of the first (509) or a second object,
a difference spectrum is formed from the first and the second spectrum, and the minimum of one wavelength (320) or a minimum of one wavelength range (206) is selected in the difference spectrum according to predetermined criteria.

2. Method according to claim 1, wherein the criteria comprise a maximal value in the difference spectrum.

3. Method according to one of the previous claims, wherein the object (509) to be tested with the minimum of one selected wavelength (320) or wavelength range (206) is illuminated.

4. Method according to one of claims 1 or 2, wherein the minimum of one selected wavelength (320) or wavelength range (206) for testing the object (509) is detected in the electromagnetic radiation issuing from the object.

5. Method according to one of the previous claims, wherein the object (509) to be tested is illuminated with a wavelength that is different from the minimum of one selected wavelength (320) or wavelength range (206).

6. Method according to one of claims 1 to 4, wherein the minimum of one selected wavelength or wavelength range for testing the object (509) is filtered out before detection in the electromagnetic radiation that issues from the object.

7. Use of a method according to one of claims 1 to 6 for testing an object in a microscope (500).

8. Microscope (500) with means of illumination (502), capture (503), and analysis (504), whereby the illumination means illuminate an object (509), and the capture means capture a first spectrum (203, 204, 205; 303, 313) on a first point of a first object,
wherein
the capture means capture a second spectrum (203, 204, 205; 303, 313) on a second point of the first or a second object, and
the analysis means form a difference spectrum as a difference between the first and the second spectrum.

9. Microscope (500) according to claim 8, wherein the selection means (505) select a minimum of one wavelength (320) or a minimum of one wavelength range (206) in the difference spectrum according to predetermined criteria.

10. Microscope (500) according to one of claims 8 to 9, wherein the capture means (503) comprises a spectral camera.

11. Microscope (500) according to one of claims 8 to 10, wherein the analysis (504) and/or selection (505) means comprise a computer unit.

12. Computer program with program coding means to implement a method according to one of claims 1 to 5 if the computer program is installed in a computer or a corresponding computer unit, in particular in the analysis (504) and/or selection (505) means in a microscope (500) according to one of claims 8 to 10.

13. Computer program product with program coding means, which are stored on a readable data carrier to implement a method according to one of claims 1 to 5 when the computer program product is installed in a computer or in a corresponding computer unit, in particular in the analysis (504) and/or selection (505) means in a microscope (500) according to one of claims 8 to 10.
